(19) United States
(12) Patent Application Publication
(10) Pub. No.: US 2010/0213841 A1
(43) Pub. Date: Aug. 26, 2010

(54) DISCHARGE LAMP, METHOD FOR PRODUCING SAME, LIGHT SOURCE DEVICE, AND PROJECTOR

(75) Inventors: Yoshihide NISHIYAMA, Chino-shi (JP); Noboru SAKURAI, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/686,767

(22) Filed: Jan. 13, 2010

(30) Foreign Application Priority Data
Feb. 26, 2009 (JP) 2009-044248

(51) Int. Cl. H01J 61/35; H01J 9/24

(52) U.S. Cl. 313/635; 445/58

(57) ABSTRACT

A discharge lamp includes an arc tube, a first protection film mainly made of a metal oxide and formed on an inner surface of the arc tube, and a second protection film mainly made of boron nitride or boron oxide and formed on the first protection film.

### CROSS-REFERENCE TO RELATED APPLICATION

This application is based on and claims priority from Japanese Patent Application No. 2009-044248, filed on Feb. 26, 2009, the contents of which are incorporated herein by reference.

### BACKGROUND

1. Technical Field

The present invention relates to a discharge lamp, a method for producing the discharge lamp, a light source device, and a projector.

2. Related Art

Conventionally, projectors are used in a variety of application areas including image projectors for presentations in meetings and home theater systems in homes. Most of the projectors incorporate a light source device such as a discharge lamp having electrodes. For example, the discharge lamp is a halogen lamp, a metal halide lamp, or a high-pressure mercury lamp.

On the other hand, the discharge lamp causes an increase in temperature when the lamp is in its on state. Thereby, there occurs devitrification due to crystallization of quartz glass used as a material of an arc tube, resulting in a reduction in transmitted light or a decrease in strength of the arc tube itself. In order to solve the problems, there are disclosed methods for forming a coating film on an inner surface of an arc tube. For example, as in JP-A-2008-270074, an yttrium oxide (Y2O3) film is formed on an inner surface of an arc tube or a hafnium oxide (HfO2) film is formed to prevent crystallization of quartz,

However, forming the yttrium oxide film having a large thickness reduces light transmission properties. In addition, the yttrium oxide film has low thermal resistance and thus can be sintered when exposed to high temperature during lighting of the discharge lamp. The hafnium oxide film tends to transmit (absorb) oxygen through the film. Accordingly, due to lighting of the discharge lamp for a long time, devitrification may occur in the film, Consequently, formation of only such a monolayer film is not enough to obtain a sufficient devitrification prevention effect and further improvement is needed.

### SUMMARY

An advantage of the invention is to provide a discharge lamp that prevents devitrification (crystallization) caused by heat generated upon electric discharge to avoid a reduction in transmitted light and a decrease in strength of an arc tube so as to obtain long-term reliability. Additionally, other advantages of the invention are to provide a method for producing the discharge lamp, a light source device, and a projector that include the discharge lamp.

To solve the above problems, a discharge lamp according to a first aspect of the invention includes an arc tube, a first protection film mainly made of a metal oxide and formed on an inner surface of the arc tube, and a second protection film mainly made of boron nitride or boron oxide and formed on the first protection film.

In the discharge lamp of the aspect, on the first protection film mainly made of a metal oxide covering the inner surface of the arc tube is formed the second protection film mainly made of boron nitride or boron oxide. The boron nitride or the boron oxide has high translucency, as well as is extremely excellent in chemical stability and thermal resistance. Accordingly, the second protection film hardly deteriorates even when exposed to high temperature when the lamp is in its on state. Additionally, the second protection film can stop transmission of oxygen that cannot be inhibited by the first protection film, thereby allowing devitrification of the arc tube to be effectively prevented in the long term. Consequently, a life span of the discharge lamp can be significantly improved.

In the discharge lamp above, preferably, the first protection film is mainly made of at least one metal oxide selected among hafnium oxide, zirconium oxide, and cerium oxide.

The hafnium oxide, the zirconium oxide, and the cerium oxide have a high melting point and thus do not easily melt. Additionally, those oxides are crystalline materials, so that the oxides have a stable structure and high thermal resistance.

In addition, preferably, the first protection film is a thin film formed by sintering particles of the metal oxide.

In the discharge lamp above, the first protection film having an even thickness can be formed on the inner surface of the arc tube.

In addition, preferably, the second protection film is a thin film formed by sintering particles of the boron nitride or of the boron oxide.

In the discharge lamp above, the second protection film having an even thickness can be formed on the first protection film.

In addition, preferably, the first protection film has a thickness ranging from 0.1 to 1 micrometers and the second protection has a thickness ranging from 0.2 to 2 micrometers.

In the discharge lamp above, no film crack occurs and thus a high devitrification prevention effect can be obtained. Accordingly, high light emission efficiency can be maintained for a long time.

In order to solve the above-described problems, a method for producing a discharge lamp according to a second aspect of the invention includes applying a liquid material including a metal oxide on an inner surface of an arc tube; heating the applied liquid material to form a first protection film mainly made of the metal oxide on the inner surface of the arc tube; and forming a second protection film mainly made of boron nitride or boron oxide on the first protection film.

In the method of the second aspect, the first protection film having an even thickness can be formed on the inner surface of the arc tube. Then, the first protection film is protected by the second protection film chemically stable and highly thermal-resistant formed on the first protection film, thereby enabling devitrification of the arc tube to be effectively prevented. As a result, the life span of the discharge lamp can be significantly improved.

Preferably, the liquid material is prepared by dispersing or dissolving particles of the metal oxide in a medium.

In the discharge lamp above, the first protection can be closely adhered to the inner surface of the arc tube by the liquid material including the metal oxide particles dispersed or dissolved in a solvent.

In addition, preferably, the second protection film formation step includes applying a liquid material prepared by dispersing or dissolving particles of the boron oxide in a medium on the first protection film and sintering the applied liquid material to form the second protection film mainly made of the boron oxide on the inner surface of the arc tube.

In the method above, the applied liquid material is prepared by dispersing or dissolving the boron oxide particles in the medium. Thereby, since cohesion among the boron oxide particles is prevented and thus dispersibility can be increased, the second protection film having an even thickness can be formed on the first protection film. Additionally, the second protection film can be formed so as to have good adhesion to the arc tube (the first protection film).

Preferably, the second protection film formation step includes applying a liquid material prepared by dispersing or dissolving particles of the boron oxide in a medium on the first protection film and sintering the applied liquid material in a presence of nitrogen and a catalyst to form the second protection film mainly made of the boron nitride on the inner surface of the arc tube.

In the method above, the liquid material prepared by dispersing or dissolving the boron oxide particles in the medium is sintered in the presence of nitrogen and the catalyst to cause reaction of the boron oxide with nitrogen and the catalyst. This allows the second protection film to be formed with an even thickness on the first protection film. Additionally, the second protection film can obtain good adhesion to the arc tube (the first protection film).

A light source device according to a third aspect of the invention includes the discharge lamp of the first aspect.

The light source device of the third aspect includes the discharge lamp having the high devitrification prevention effect and the long life, so that the light source device can achieve light emission with high luminance in the long term and thus can exhibit high reliability.

A projector according to a fourth aspect of the invention includes the light source device of the third aspect.

The projector of the fourth aspect includes the light source device that can achieve light emission with high luminance in the long term. Thus, the projector can achieve high visibility and high definition.

### BRIEF DESCRIPTION OF THE DRAWINGS

The invention will be described with reference to the accompanying drawings, wherein like numbers reference like elements.

FIG. 1 is a plan view showing an entire structure of a light source device according to an embodiment of the invention.

FIG. 2 is a sectional view showing a schematic structure of a discharge lamp according to an embodiment of the invention.

FIG. 3 is a micrograph showing devitrification of quartz glass.

FIG. 4 is a micrograph showing devitrification of quartz glass covered with a hafnium oxide (HfO₂) film.

FIG. 5 is a micrograph showing devitrification of quartz glass covered with a zirconium oxide (ZrOz) film.

FIG. 6 is a micrograph showing devitrification of quartz glass covered with a boron nitride (BN) film.

FIG. 7 is a graph showing light transmittances of the respective quartz glasses covered with the films that are made of HfO₂ and BN, respectively.

FIG. 8 is a schematic structural view of a projector according to an embodiment of the invention.

### DESCRIPTION OF EXEMPLARY EMBODIMENTS

Embodiments of the invention will be described with reference to the drawings. Among the drawings referred to in the description below, scales of respective constituent elements vary according to needs to make the elements visually discernible.

### First Embodiment

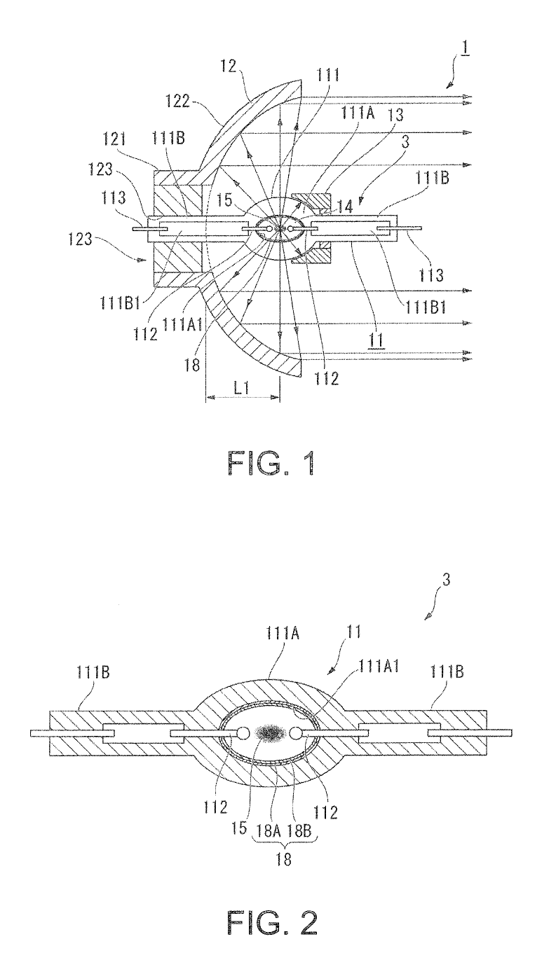

FIG. 1 is a plan view showing an entire structure of a light source device according to an embodiment of the invention. FIG. 2 is a sectional view showing a schematic structure of a discharge lamp according to an embodiment of the invention.

A light source device 1 of the embodiment is suitably incorporated in a projector, which will be described later. The light source device 1 includes a reflector 12 and a discharge lamp 3 of the embodiment arranged inside the reflector 12. The discharge lamp 3 includes an arc tube 11 made of quartz glass (SiO₂) and a pair of electrodes 112 arranged inside the arc tube 11. A light emitting substance is enclosed in the arc tube 11.

The arc tube 11 includes a bulging portion 111A as a spherically bulging center and enclosing portions 111B extended on opposite sides of the bulging portion 111A. Inside the bulging portion 111A is formed a light emission region 14 in which the light emitting substance is filled (an enclosing space where a light emission gas is enclosed). The light emission region 14 has an inner diameter of approximately 1 to 2 millimeters, for example.

In the enclosing portions 111B, bar-shaped electrodes 112 are arranged in such a manner that one-side top ends of the electrodes 112 are spaced apart from each other. The electrodes 112 are suitably made of a conductive material, particularly, a material having a small thermal expansion coefficient and a high level of thermal resistance, Specifically, tungsten is suitable.

When the top ends of the electrodes 112 are arranged in the light emission region 14 of the arc tube 11, reaction of the electrode material with the gas seems to cause corrosion of the metal material of the electrodes depending on a kind of the gas filled in the light emission region 14. In this case, it is desirable to form a corrosion resistant film or the like.

Inside the respective enclosing portions 111B, respective foils 111B1 made of molybdenum are inserted and electrically connected to the pair of respective electrodes 112. The foils 111B1 are enclosed in glass or the like. The respective foils 111B1 are connected to respective leading wires 113 as electrode leading wires. The leading wires 113 are extended outside the discharge lamp 3.

The light emitting substance filled in the light emission region 14 includes mercury, a rare gas, and a halogen compound. An amount of the mercury filled may range from 0.15 mg/mm³ to 0.32 mg/mm³, and is preferably enclosed at a vapor pressure of 150 to 190 bars.

The rare gas is used to promote light emission performed by a light emitting portion and is not restricted to a specific gas. For example, the rare gas may be a commonly used gas such as argon gas or xenon gas.

In addition, the halogen compound may be a halogen selected among chlorine, bromine, and iodine. Among them, particularly, bromine is preferable.

As shown in FIGS. 1 and 2, the arc tube 11 of the embodiment includes a devitrification preventing film 18 to prevent devitrification of the arc tube 11. The devitrification preventing film 18 is provided on an inner surface 111A1 of the bulging portion 111A.

The devitrification preventing film 18 includes a first protection film 18A mainly made of a metal oxide and a second protection film 18B mainly made of boron nitride (BN) or boron oxide (B₂O₃). The first protection film 18A is formed on the inner surface 111A1 and then the second protection film 18B is formed on the first protection film 18A. Thereby, the devitrification preventing film 18 is a two-layer film and covers an entire part of the inner surface 111A1 of the bulging portion 111A.

The first protection film 18A is a thin film mainly made of at least one of hafnium oxide (HfO₂), zirconium oxide (ZrO₂), and cerium oxide (CeO₂). The oxide materials have thermal resistance, so that the materials do not easily crystallize even when exposed to high temperature during lighting of the lamp and thus formation of an island structure hardly occurs.

The second protection film 18B is a thin film formed by sintering boron nitride particles or boron oxide particles, and thus is excellent in light transmission properties and thermal resistance. In other words, the second protection film 18B mainly made of BN or B₂O₃ has a chemically stable structure and hardly deteriorates even when exposed to high temperature for a long time. In addition, the second protection film 18B can stop transmission of oxygen, thereby preventing oxidization of the first protection film 18A, ultimately leading to an inhibition of reaction between the filled substance at high temperature due to electric discharge and the inner surface 111A1 of the arc tube 11.

The embodiment uses a laminated-layer film including the first and the second protection films 18A and 18B as the devitrification preventing film 18, whereby the first protection film 18A prevents crystallization of the arc tube 11 and the second protection film 18B protects the first protection film 18A as its underlayer to thereby maintain a good film condition of the devitrification preventing film 18. Consequently, devitrification of the arc tube 11 can be prevented in the long term.

A film thickness of the devitrification preventing film 18 varies depending on the light emitting substance or the like enclosed in the arc tube 11. For example, the first protection film 18A may have a thickness ranging from 0.1 to 1 micrometers, and the second protection film 18B may have a thickness ranging from 0.2 to 2 micrometers.

If the film thickness of the first protection film 18A is less than 0.1 micrometers, the devitrification prevention effect cannot be much expected. If the film thickness exceeds 1 micrometer, translucency may be reduced. Conversely, the second protection film 18B is highly translucent and thus can be made relatively thick.

The reflector 12 is an integrally molded article made of glass and includes a neck-shaped portion 121 through which the enclosing portions 111B of the discharge lamp 3 are inserted and a reflecting portion 122 having a curved planar shape extended from the neck-shaped portion 121.

At a center of the neck-shaped portion 121 is formed an insertion hole 123, and the enclosing portions 111B are arranged in a center of the insertion hole 123.

The reflecting portion 122 is formed by vapor-depositing a metal thin film on an inner surface of the glass having the curved plane. A reflecting surface of the reflecting portion 122 serves as a cold mirror reflecting visible light and transmitting infrared light therethrough.

The discharge lamp 3 is arranged inside the reflecting portion 122 in such a manner that a center of light emission between the electrodes 112 inside the bulging portion 111A is located at a focus position L1 of the curved plane of the reflecting portion 122.

Then, when the discharge lamp 3 is turned on, a flux of light emitted from the bulging portion 111A is reflected on the reflecting surface of the reflecting portion 122 to become parallel light rays, as shown in FIG. 1.

When fixing the discharge lamp 3 to the reflector 12 thus formed, the enclosing portions 111B of the discharge lamp 3 are inserted in the insertion hole 123 of the reflector 12 to fill an inorganic adhesive mainly containing silica or alumina in the insertion hole 123.

A sub reflection mirror 13 is a reflecting member that covers a front side in a light flux emission direction of the light emission region 14 of the bulging portion 111A. A reflecting surface of the sub reflection mirror 13 is formed into a concavely curved plane following a spherical surface of the light emission region 14 (the inner surface 111A1 of the arc tube 11). The reflecting surface thereof serves as a cold mirror, similarly to the reflector 12.

Preferably, the sub reflection mirror 13 covers a portion ranging from approximately a half to a third of the front side in the light flux emission direction of the light emission region 14 of the bulging portion 111A.

In the discharge lamp 3 described above, when voltage is applied to the leading wires 113 extended outwardly from the enclosing portions 111B, electric discharge occurs between the electrodes 112, thereby causing light emission of a light emitting portion 15. Then, a part of a light flux emitted forwardly from the bulging portion 111A of the discharge lamp 3 is reflected on the reflecting surface of the sub reflection mirror 13 to be returned to the bulging portion 111A. Next, energy of a part of the returned light is absorbed by the substance enclosed in the light emission region 14 of the bulging portion 111A, whereas a remaining part of the returned light travels into the reflector 2 to be emitted from the reflecting portion 122 of the reflector 12.

As described above, the light source device 1 of the embodiment includes the devitrification preventing film 18 as the laminated-layer film in which the first protection film 18A is formed on the inner surface 111A1 of the arc tube 11 and then the second protection film 18B is formed on the first protection film 18A. The first protection film 18A is mainly made of at least one of hafnium oxide (HfO₂), zirconium oxide (ZrO₂), and cerium oxide (CeO₂), and the second protection film 18B is mainly made of boron nitride (BN) or boron oxide (B₂O₃).

The boron nitride or boron oxide not only has high translucency but also has high chemical stability and high thermal resistance. Accordingly, even when the inner surface 111A1 of the arc tube 11 is exposed to high temperature for a long time during continuous lighting of the discharge lamp 3, no crack or the like occurs and thus, a good condition of the film can be maintained. This allows prevention of devitrification of the arc tube 11 in the long term.

In addition, the second protection film 18B can stop transmission of oxygen that cannot be prevented by the first protection film 18A. Oxygen is a factor that promotes devitrification of the arc tube 11. Thus, stopping oxygen transmission can further ensure that the devitrification of the arc tube 11 can be prevented.

In addition, forming the second protection film 18B on the first protection film 18A on the inner surface 111A1 of the arc tube 11 allows adhesion of the second protection film 18B to the arc tube 11 to be maintained, thereby preventing separation from the inner surface 111A1. Consequently, for example, reaction between the arc tube 11 and the light emitting substance can be inhibited and thus devitrification can be effectively prevented, so that light emission with high luminance can be maintained for a long time.

As described hereinabove, on the inner surface 111A1 of the arc tube 11 are formed the transparent ceramic thin film and the coating film made of BN or B₂O₃ in the multilayer structure. This leads to the inhibition of reaction between the light emitting substance (a metal halogen substance) enclosed in the arc tube 11 or the electrode material (tungsten) and the arc tube 11 (quartz glass, high silica glass, or the like), thereby preventing deterioration, color changes, or devitrification occurring in the arc tube 11. Particularly, the second protection film 1813 made of BN or B₂O₃ located in the second layer position is chemically stable and extremely excellent in thermal resistance. Accordingly, coating the inner surface 111A1 of the arc tube 11 with the second protection film 18B can significantly improve the life span of the discharge lamp 3.

Next, a description will be given of a method for producing the described-above light source device according to an embodiment of the invention. The description below will provide details of steps for forming the devitrification preventing film 18 as a characteristic part of the embodiment, and descriptions of steps for forming other parts will be omitted since the steps are the same as in the conventional art.

First Protection Film Formation Step

First, transparent particles of at least one of hafnium oxide (HfO₂), zirconium oxide (ZrO₂), and cerium oxide (CeO₂) are dispersed or dissolved in a dispersion medium to prepare a liquid material. Then, the liquid material is applied on the inner surface 111A1 of the arc tube 11, dried and then sintered at a predetermined temperature to form the first protection film 18A.

Second Protection Film Formation Step

When forming the second protection film 18B made of boron oxide (B₂O₃), a liquid material is prepared by dispersing or dissolving boron oxide particles in a dispersion medium to be applied on the first protection film 18A. Next, the applied liquid material is dried and then sintered at a predetermined temperature to form the second protection film 18B made of B₂O₃ on the first protection film 18A.

In formation of the second protection film 18B made of boron nitride (BN), a liquid material prepared by dispersing or dissolving particles of B₂O₃ in a dispersion medium is applied on the first protection film 18A. Next, the applied liquid material is sintered in a presence of nitrogen and a catalyst made of calcium phosphate to form the second protection film 12B made of BN.

Instead of the above-described method, a mixture of the boron oxide particles and calcium phosphate may be applied on the first protection film 18A to cause reaction sintering between the B₂O₃ and the calcium phosphate in the nitrogen atmosphere to form the second protection film 18B made of BN.

In the method described hereinabove, using the liquid material prepared by dispersing (dissolving) the boron nitride particles in the dispersion medium leads to a prevention of cohesion among the boron nitride particles, resulting in improvement of dispersibility of the particles. Thereby, the second protection film 18B having an even thickness can be formed on the first protection film 18A.

In addition, causing the reaction sintering between the boron oxide and the calcium phosphate in the nitrogen atmosphere allows formation of the second protection film 18B having the even thickness on the first protection film 18A.

Furthermore, the first protection film 18A can increase adhesion of the BN film or the B₂O₃ film (the second protection film 18B) to the arc tube 11, thereby preventing separation of the devitrification preventing film and the like.

Evaluations of Devitrification Resistance

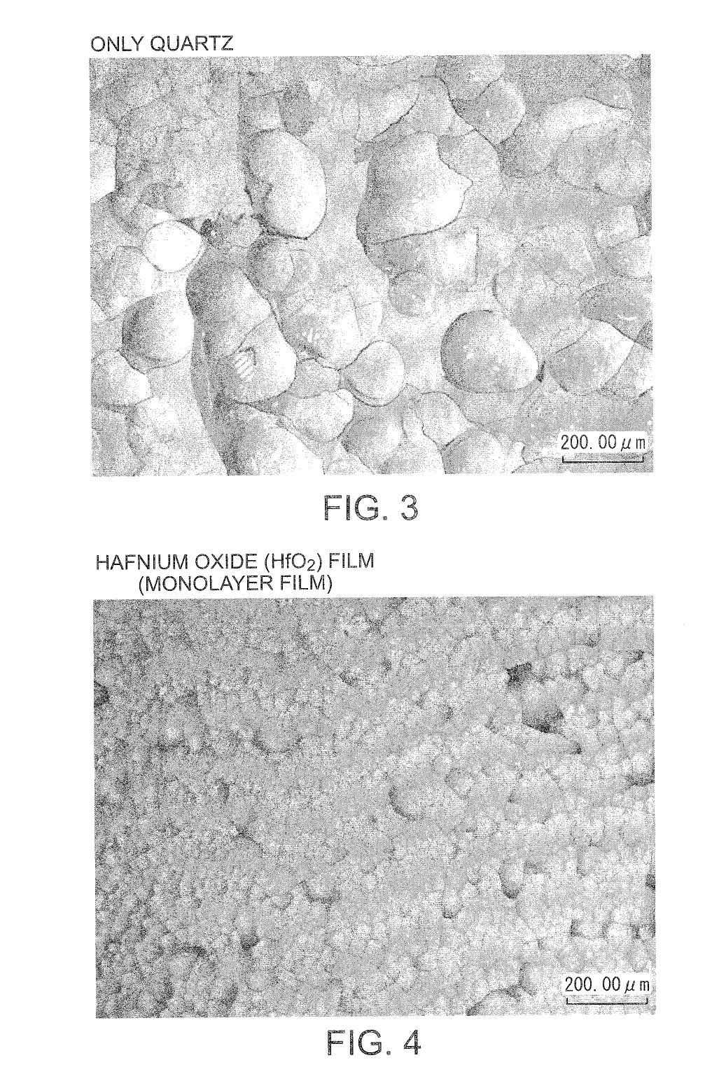

Next, evaluations of devitrification resistance were performed for a plurality of quartz glass materials having surfaces covered with a hafnium oxide film, a zirconium oxide film, and a boron nitride film, respectively, and a quartz glass material whose surface was not covered with any film. FIGS. 3 to 6 show conditions observed after heating the respective quartz glass materials at 1300° C. for 50 hours.

As shown in FIG. 3, in the quartz glass material having the surface not covered with any film, multiple crystal nucleuses were generated with relatively large and uneven sizes in an approximately entire region. Higher the heating temperature, faster the speed of crystal growth. The crystal growth speed is influenced by an impurity included in a surrounding atmosphere. A presence of many impurities can significantly change a speed that promotes devitrification. Accordingly, in the quartz glass having the surface uncovered with any film, devitrification proceeded rapidly.

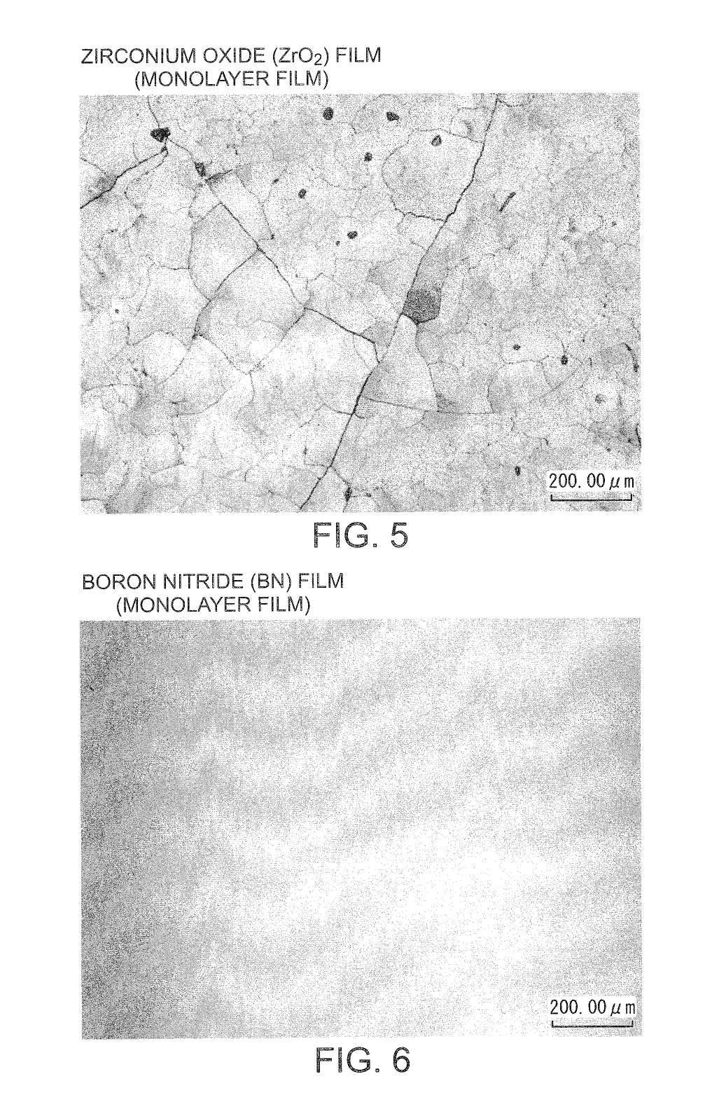

In addition, as shown in FIGS. 4 and 5, the respective quartz glass materials having the HfO₂ film and the ZrO₂ film, respectively, were deteriorated due to heat generated upon electric discharge.

Meanwhile, as shown in FIG. 6, the quartz glass with the BN film was not deteriorated at all even when exposed to high temperature for a long time.

The results above ensure that the boron nitride film has high thermal resistance. This shows that forming a boron nitride film can provide a longterm devitrification prevention effect, which cannot be obtained by a monolayer film of hafnium oxide or zirconium oxide. Accordingly, covering the surface of the arc tube made of quartz glass by using the boron nitride film allows prevention of reaction between the light emitting substance at high temperature in the arc tube and the quartz glass, thereby preventing devitrification of the arc tube in the long term. Additionally, evaporation of quartz glass (SiO₂) due to heat generated upon lighting of the discharge lamp is also prevented. Thus, separation and generation of oxygen is not caused in the arc tube, so that promotion of devitrification can be inhibited.

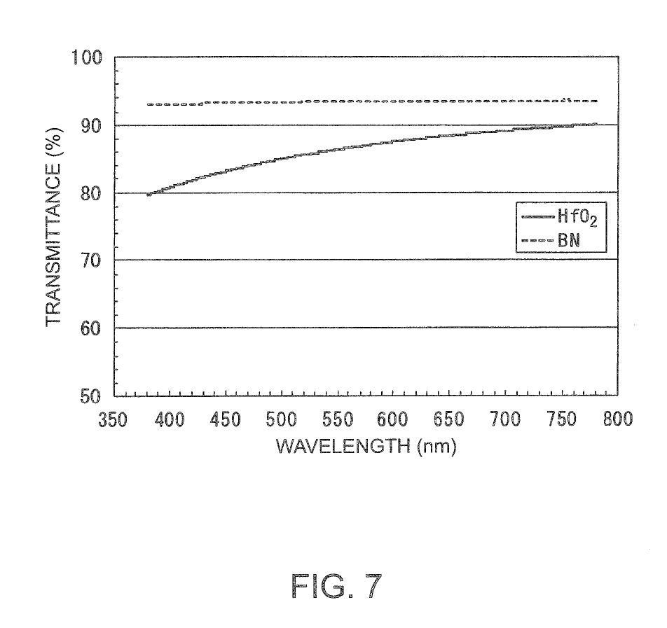

FIG. 7 is a graph showing light transmittances of the respective quartz glass materials having the hafnium oxide (HfO₂) film and the boron nitride (BN) film, respectively, formed thereon. A vertical axis represents transmittances (%) and a lateral axis represents wavelengths (nm).

The quartz glass with the HfO₂ film has a transmittance of 80% in an ultraviolet region and a transmittance of 90% in an infrared region and thus exhibits the high transmittances in the high wavelength regions. Meanwhile, the quartz glass with the BN film has transmittances of 90% or higher in all of the ultraviolet region, a visible region, and the infrared region. Accordingly, it can be found that the boron nitride film has higher light transmission properties than the hafnium oxide film in a broad range of wavelength regions.

Projector

Next, a description will be given of a projector according to an embodiment of the invention. The projector includes the light source device of the embodiment described above.

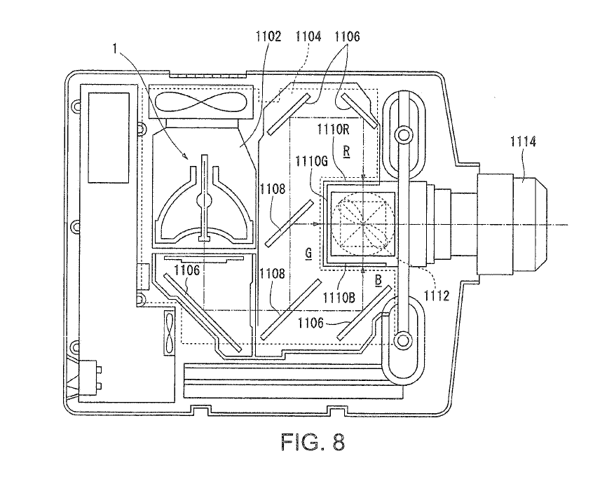

FIG. 8 is a plan view showing a structural example of the projector of the embodiment. As shown in the drawing, inside a projector 1100 is provided a lamp unit 1102 including the light source device 1 of the embodiment. Projection light emitted from the lamp unit 1102 is split into light rays of three primary colors of red (R), green (G), and blue (B) by four mirrors 1106 and two dichroic mirrors 1108 arranged in a light guide 1104 to be input to respective liquid crystal panels (light modulation sections) 1110R, 1110B, and 1110G as light valves corresponding to the respective primary colors.

The liquid crystal panels 11108, 1110B, and 1110G have a same structure as that of the liquid crystal device described above and are driven by signals of the primary colors R, G, and B supplied from an image signal processing circuit. Light rays modulated by the liquid crystal panels are input to a dichroic prism 1112 from three directions. In the dichroic prism 1112, light rays of red and blue are refracted at an angle of 90 degrees, whereas a green light ray travels straight. Consequently, images of the respective colors are synthesized, resulting that a color image is projected on a screen or the like via a projection lens 1114 (a projection section). Regarding display images provided by the liquid crystal panels 1110R, 1110B, and 1110G, the display image by the liquid crystal panel 1110G needs to be laterally reversed with respect to the display images by the liquid crystal panels 111OR and 1110B.

The projector 1100 includes the light source device 1 of the above-described embodiment. In the light source device 1, devitrification of the arc tube 11 is prevented in the long term, and thus, illumination light with high luminance can be obtained in the long term. Accordingly, the projector 1100 has a long life and can provide projection images having high display quality and high reliability. Additionally, the projector 1100 including the compact light source device 1 can be entirely miniaturized and light-weighted.

Furthermore, in the projector 1110 of the embodiment, the liquid crystal panels are used as the light modulation sections. However, instead of the liquid crystal panels, in general, any device that can modulate incident light in accordance with image information can be used as a light modulation section. For example, there may be used a micro-mirror type light modulation device, such as a digital micro-mirror device (DMD, registered as a trademark). If the DMD is used, there are no needs for an incident light polarizing plate or an output light polarizing plate. Thus, no polarization conversion element is necessary.

The light source device 1 of the embodiment is applied to the projector 1100 of a transmissive liquid crystal system. However, instead of that, the light source device 1 can also be applied to a projector employing a reflective liquid crystal system, such as a liquid-crystal-on-silicon (LCOS) system, so as to obtain same advantageous effects.

The light modulation sections of the above embodiment may be structured by a three-plate system using the three liquid crystal panels or by a single plate system using a single liquid crystal panel. If the single plate system is used, it is unnecessary to provide a color split optical system, a color synthesis optical system, and the like for an illumination light system.

In addition, in the embodiment, the light source device 1 is applied to a front-type projector projecting an optical image on a projecting surface arranged outside the projector. However, alternatively, the light source device 1 may be applied to a rear-type projector having a screen thereinside to project an optical image on the screen inside the projector.

While some preferred embodiments of the invention have been described with reference to the accompanying drawings, it should be understood that the invention is not intended to be limited to those embodiments, and for example, the embodiments may be combined together. It will be obvious to those skilled in the art that various changes and modifications can be made therein without departing from the scope of technological ideas described in the claims of the invention, and those changes and modifications are naturally included in the technological range of the invention.

For example, the light source device 1 of the above embodiment can employ a microwave power source or an AC power source.

Additionally, although the light source device 1 of the embodiment is used as the light source for the projector, the compact and light-weighted light source device of the embodiment may also be applied to other optical apparatuses, as well as can be suitably applied to lighting apparatuses of transportation systems such as aircraft, ships, and vehicles, indoor lighting apparatuses, and the like.

What is claimed is:

1. A discharge lamp, comprising:
an arc tube;
a first protection film mainly made of a metal oxide and formed on an inner surface of the arc tube; and
a second protection film mainly made of boron nitride or boron oxide and formed on the first protection film.

2. The discharge lamp according to claim 1, wherein the first protection film is mainly made of at least one metal oxide selected among hafnium oxide, zirconium oxide, and cerium oxide.

3. The discharge lamp according to claim 1, wherein the first protection film is a thin film formed by sintering particles of the metal oxide.

4. The discharge lamp according to claim 1, wherein the second protection film is a thin film formed by sintering particles of the boron nitride or of the boron oxide.

5. The discharge lamp according to claim 1, wherein the first protection film has a thickness ranging from 0.1 to 1 micrometers and the second protection has a thickness ranging from 0.2 to 2 micrometers.

6. A method for producing a discharge lamp, comprising:
applying a liquid material including a metal oxide on an inner surface of an arc tube;
heating the applied liquid material to form a first protection film mainly made of the metal oxide on the inner surface of the arc tube; and
forming a second protection film mainly made of boron nitride or boron oxide on the first protection film.

7. The method for producing a discharge lamp according to claim 6, wherein the liquid material is prepared by dispersing or dissolving particles of the metal oxide in a medium.

8. The method for producing a discharge lamp according to claim 6, wherein the second protection film formation step includes applying a liquid material prepared by dispersing or dissolving particles of the boron oxide in a medium on the first protection film and sintering the applied liquid material to form the second protection film mainly made of the boron oxide on the inner surface of the arc tube.

9. The method for producing a discharge lamp according to claim 6, wherein the second protection film formation step includes applying a liquid material prepared by dispersing or dissolving particles of the boron oxide in a medium on the first protection film and sintering the applied liquid material in a presence of nitrogen and a catalyst to form the second protection film mainly made of the boron nitride on the inner surface of the arc tube.

10. A light source device including the discharge lamp of claim 1.

11. A projector including the light source device of claim 10.
